(19) United States
(12) Patent Application Publication
(10) Pub. No.: US 2025/0224572 A1
(43) Pub. Date: Jul. 10, 2025

(54) FIBER OPTIC CONNECTORS HAVING AN OUTER HOUSING WITH A LONGITUDINAL OPEN SLOT

(71) Applicant: CORNING RESEARCH & DEVELOPMENT CORPORATION, Corning, NY (US)

(72) Inventor: Thomas Theuerkorn, Hickory, NC (US)

(21) Appl. No.: 19/088,067

(22) Filed: Mar. 24, 2025

Related U.S. Application Data
(63) Continuation of application No. PCT/US2022/050855, filed on Nov. 23, 2022.
Application No. PCT/US2022/050855 is a continuation of application No. PCT/US2022/044997, filed on Sep. 28, 2022.
(60) Provisional application No. 63/249,855, filed on Sep. 29, 2021.

(51) Int. Cl. G02B 6/38

(52) U.S. Cl. CPC G02B 6/3893; G02B 6/3831; G02B 6/3849; G02B 6/3853; G02B 6/3887

(57) ABSTRACT

Fiber optic connectors having an outer housing comprising a longitudinal open slot disposed on a first side and a latching trigger disposed on a second side are disclosed. The longitudinal open slot of the outer housing allows easy removal and/or replacement of the outer housing by simplifying the assembly of the connector as well as enabling inspection or service as needed. The outer housing may also include a transverse wall at the rear end for providing a ferrule assembly position assurance when the outer housing is properly attached to the optically mated fiber optic connector. Connectors may use fiber-based or lens-based optical interfaces along with other optional features such as sealing gasket disposed on the ferrule assembly to protect when mated, a sealing membrane disposed on a front opening of the connector housing for inhibiting moisture, dirt, debris or dust from reaching the optical interface prior to optical mating.

### CROSS-REFERENCES TO RELATED APPLICATIONS

This application is a continuation of International Application No. PCT/US2022/050855 filed on Nov. 23, 2022, which is a continuation of International Application No. PCT/US2022/044997 filed on Sep. 28, 2022, which claims priority to U.S. Provisional Application No. 63/249,855, filed on Sep. 29, 2021, the content of which is relied upon and incorporated herein by reference in its entirety.

### FIELD

The disclosure is directed to fiber optic connectors having an outer housing comprising a longitudinal open slot disposed along the length on a first side and a latching trigger disposed on a second side of the outer housing. The longitudinal open slot of the outer housing allows easy removal and/or replacement of the outer housing as needed. Removal of the outer housing advantageously simplifies assembly of the fiber optic connector as well as enabling inspection or service as needed. The outer housing may also provide position assurance for one or more ferrule assemblies when the outer housing is properly attached to the fiber optic connector.

### BACKGROUND

Optical fiber is increasingly being used for a variety of applications, including but not limited to broadband voice, video, and data transmission in a variety of new and expanding applications. As bandwidth demands increase optical fiber is migrating deeper into new communication networks such as fiber for in-vehicle optical networks and the like. As optical fiber extends deeper into these communication networks there exist a need for quickly and easily making optical connections in a quick and easy manner while meeting the environmental and other demands for these emerging applications.

Fiber optic connectors were developed for making one or more plug and play optical connections using a suitable fiber optic connector for the given application. Fiber optic connectors provide a node for mating and unmating in the optical network and provide the flexibility of locating the connection points in convenient locations for efficient network assembly, access, design and/or deployment. Conventional fiber optic connectors used for telecommunications, are used indoors or inside enclosures for inhibiting moisture, dust, dirt or debris or the like from reaching the mating interface of the fiber optic connector. Hardened fiber optic connectors were developed for outdoor applications that for inhibiting moisture, dust, dirt or debris or the like from reaching the mating interface of the fiber optic connector. However, these hardened fiber optic connectors developed for outdoor applications are relatively large, bulky and/or expensive.

As new applications emerge for the deployment of optical networks the requirements for these new applications may be different and/or have other considerations for the given application. One such emerging application is the use of optical systems on vehicles that present a new environment with specific challenges for successful deployment in a harsh environment while requiring a relatively compact footprint in a robust and reliable package while enabling inspection and serviceability, ease of manufacture and the like. Consequently, there exists an unresolved need for robust fiber optic connectors with a robust design for preserving optical performance, providing flexibility for assembly, and the ability to inspect and service the fiber optical connector.

### SUMMARY

The disclosure is directed to fiber optic connectors having an outer housing comprising a longitudinal open slot extending from a front end to a rear end of the outer housing on first side. The longitudinal open slot allows the fiber optic cable of a terminated connector to be able to pass through the longitudinal open slot of the outer housing for providing flexibility in the assembly order for the fiber optic connector as well as allowing removal of the outer housing for inspection or service of the fiber optic connector if needed. A second side of the outer housing may comprise a latching trigger for unplugging the fiber optic connector. The disclosed concepts are advantageous since they provide a fiber optic connector with an outer housing that is removable and/or re-installable about a terminated connector as needed while providing a compact, robust and reliable fiber optic connector package that also enables serviceability, ease of assembly and the like.

The fiber optic connectors disclosed provide a simple design that may also allow other features. For instance, the connector concepts allow keying of individual connectors as desired for applications such as automotive applications or the like that may desire to exclude incorrect connections during assembly.

One aspect of the disclosure is directed to fiber optic connectors comprising at least one ferrule assembly comprising a bore extending from a rear end into the ferrule assembly and an optical interface disposed at a front end of the ferrule assembly, and an optical fiber disposed within the bore of the ferrule assembly. The fiber optic connectors also include a connector housing having a passageway extending from a rear end to a front end and the ferrule assembly is at least partially disposed within the passageway, and an outer housing comprising a longitudinal open slot extending from the front end to the rear end and disposed on a first side off the outer housing along with a latching trigger disposed on a second side of the outer housing.

Another aspect of the disclosure is directed to fiber optic connectors comprising a ferrule comprising a bore extending from a rear end into the ferrule and an optical interface disposed at a front end of the ferrule along with a ferrule holder. The ferrule holder has a forward portion and a rearward portion with a shoulder disposed between the forward portion and the rearward portion, and the ferrule is attached to the ferrule holder to form a ferrule assembly, and an optical fiber disposed within the bore of the ferrule. The fiber optic connectors also include a connector housing having a passageway extending from a rear end to a front end and the ferrule assembly is at least partially disposed within the passageway, and an outer housing comprising a longitudinal open slot extending from the front end to the rear end and disposed on a first side off the outer housing along with a latching trigger disposed on a second side of the outer housing. The rear end of the outer housing comprises a transverse wall for inhibiting the at least one ferrule assembly from being displaced from the passageway of the connector housing.

Still other aspects of the disclosure are directed to a method of making fiber optic connectors. The methods of making comprising assembling a ferrule into a ferrule holder to form a ferrule assembly where the ferrule comprises a bore extending from a rear end into the ferrule and an optical interface disposed at a front end of the ferrule, and an optical fiber is placed within the bore of the ferrule. The method includes inserting the ferrule assembly into a passageway of a connector housing extending from a rear end to a front end so that the ferrule assembly is at least partially disposed within the passageway, and placing an outer housing comprising a longitudinal open slot extending from the front end to the rear end about a connector housing. The outer housing may include a latching trigger as disclosed or not. Likewise, the rear end of the outer housing may comprise a transverse wall for inhibiting the at least one ferrule assembly from being displaced from the passageway of the connector housing.

Many variations using the fiber optic connector concepts disclosed are possible. For instance, the fiber optic connectors may use a single ferrule assembly or fiber optic connectors may include multiple ferrule assemblies such as configured as a duplex connector or other configurations as desired. Additionally, the ferrule assembly of the fiber optic connector may be configured for physical contact or a lens-based optical transmission as desired.

Still other variations are possible for making a robust fiber optic connector. By way of explanation, the fiber optic connectors may further include a sealing gasket disposed within a passageway of the connector housing for providing an internal sealing cavity within the passageway of the fiber optic connectors when mated if desired, thereby providing environmental protection within the passageway of the connector housing that houses the optical interface.

The disclosed connector concepts also allow quick and easy manufacture and assembly of the connector in a reliable, modular and configurable connector package. Additionally, the fiber optic connectors disclosed may be a portion of a cable assembly used in a vehicle or other applications.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a top perspective view of an optical mating of cable assemblies having explanatory fiber optic connectors configured as a male plug that is mated to a fiber optic connector configured as a female receptacle with the male plug connector having an outer housing with a longitudinal open slot disposed on the bottom of the outer housing (not visible);

FIG. 2 is a bottom perspective sectional view of unplugging of the fiber optic plug of FIG. 1 showing details of the longitudinal open slot disposed on the bottom of the outer housing along with the latch features disposed in the longitudinal open slot;

FIG. 3 is a is a top perspective view of an optical mating of the fiber optic connectors of FIG. 1 with the outer housing of the male plug shown in ghost lines for showing an explanatory optional keying arrangement for the fiber optic connectors;

FIG. 4 is partial perspective sectional view of a representative optical mating of the fiber optic connectors similar to FIG. 1 showing the details for the cooperation between the outer housing and the other components of the fiber optic connector;

FIG. 5 is a perspective view of an explanatory fiber optic connector having an optional sealing membrane attached to a front end of the connector housing for inhibiting contaminants from reaching the optical interface prior to optical mating of the fiber optic connector;

FIG. 6 is a partial perspective sectional view of the connector housing of the fiber optic connector of FIG. 1 showing the terminated ferrule assembly having an optional sealing gasket and a dust cap being inserted into a passageway of the connector housing of an explanatory connector; and

FIG. 7 depicts a cross-sectional view of the optical mating of the fiber optic connectors similar to FIGS. 1 and 6 configured as a male plug and female receptacle having respective ferrule assemblies with a sealing gasket disposed on the ferrule assemblies and within the passageway of the connector housing such as shown in FIG. 6.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed are related to fiber optic connectors (hereinafter “connectors”) suitable for use in applications that may be exposed to the environment such as temperature variations, moisture, dirt, dust, debris or the like. Suitable applications may include communication systems for vehicles using on-board optical systems such as automotive applications, trucks, motorcycles, aerospace, farm equipment, ships or the like, but other applications are possible for concepts disclosed. The connectors disclosed comprise an outer housing comprising a longitudinal open slot disposed along the length extending from a rear end to a front end on a first side and a latching trigger disposed on a second side of the outer housing. The longitudinal open slot of the outer housing allows easy assembly, removal and/or replacement of the outer housing onto the cable assembly as needed. Flexibility in the installation during assembly or removal of the outer housing from the connector advantageously simplifies assembly of the connector as well as enabling inspection or service as needed. The outer housing may also provide position assurance for one or more ferrule assemblies of the connector. For instance, a transverse wall near the rear end of the outer housing can provide ferrule assembly position assurance (FAPA) when the outer housing is properly attached to the fiber optic connector.

The connectors may also optionally comprise other features for maintaining cleanliness of the optical interface of the connector before or after mating as desired. For instance, a sealing membrane may be disposed on the front opening of the connector housing for keeping the optical interface of the connector clean until mating of the connector is required. Thus, the sealing membrane is advantageous for cleanliness before optical mating such as during assembly of wiring harness using the connector to protect the optical interface. Additionally, the connector may advantageously provide environmental protection or cleanliness for the optical interface after being mated by using one or more sealing gaskets as desired. For instance, the sealing gasket(s) may be disposed on the ferrule assembly so that the sealing gasket provides environmental protection when the connector is optically mated with a suitable device such as a complimentary connector, transceiver or other suitable device. When assembled, the sealing gasket is disposed within a passageway of the connector housing, and should not be confused with seals disposed on the outer surface of the connector housing. Instead, locating the sealing gasket on the ferrule assembly within the connector housing provides an internal sealing cavity for the optical mating within the passageway of the connector housing, thereby providing environmental protection when connector is in the mated state. The connector concepts also allow quick and easy manufacture and assembly of the connector in a reliable, modular and configurable connector package.

The connector concepts using the outer housing or other features may be used with ferrule assemblies having an optical interface that uses physical contact between optical fibers or using lenses for optical mating as desired. As used herein, the term “ferrule assembly” may comprise a single component or multiple components. By way of example, the ferrule assembly could be formed as a single molded component if desired or formed from multiple components such as a ferrule holder with a ferrule.

The connector concepts disclosed may be used as part of a larger wiring harness or device. For instance, the connector may be constructed as a portion of a larger wiring harnesses or sub-assembly built by a contractor for future installation into vehicles or other devices during the manufacturing process.

Of course, the concepts disclosed may be used in other applications such as in-home networks or the like. For instance, the concepts disclosed herein may also be suitable for fiber optic networks such as for Fiber-to-the-location (FTTx) and 5G applications, and are equally applicable to other optical applications as well including indoor, industrial, wireless, or other suitable applications. Additionally, the concepts disclosed may be used with fiber optic connectors having any suitable footprint, configuration or construction. Reference to “forward”, “front”, “rearward” and “rear”, “top” or “bottom” as used herein are relative terms that generally relate to the orientation of the fiber optic connector where the front or forward portion is with respect to the direction of the mating end of the fiber optic connector or component(s) and the rear or rearward portion is with respect to the direction of the portion of the fiber optic connector where the fiber optic cable is first inserted into the fiber optic connector or component(s). Various components or structures are described in this disclosure as being forward or rearward relative to one another. Various designs, constructions, or features for fiber optic connectors are disclosed in more detail with respect to explanatory embodiments as discussed herein and may be modified or varied as desired.

Connectors 100 according to the concepts disclosed may also support one or more ferrule assemblies 60 as desired for the application. Connector 100 comprise at least one ferrule assemblies 60 that may terminate any suitable optical fiber 92 or fiber optic cable 90 as desired. Fiber optic cable 90 includes at least optical fiber 92 that may be disposed within the bore 62 of the ferrule assembly 60. Optical fibers 92 may be any suitable optical fiber for transmitting optical signals and may include multi-mode or single-mode optical fibers, and other suitable optical fibers are possible according to the concepts disclosed. Likewise, optical fiber 92 may have any suitable size for the optical core, cladding or coating desired for the communication system. For instance, the optical fiber 92 may be an OM3 compliant fiber, but other suitable optical fibers are possible. Optical fiber 92 may have a buffer layer to upsize the diameter and/or protect the optical fiber to form the fiber optic cable 90 such as a 500 um or 700 um.

Fiber optic cable 90 may also include features such as a cable jacket, strength members, ripcords or the like. By way of example, fiber optic cable 90 could be a two-fiber zipcord having a cable jacket that may be separated for separating the optical fibers 92 into separate legs along a portion of the cable for a duplex connector. Other cable types are possible as well such as a round cable if desired.

Connector 100 include other components as desired such as a connector housing 140 comprising a passageway 142 extending from a rear end 141 to a front end 143. When assembled, the ferrule assembly 60 is at least partially disposed within the passageway 142. An outer housing 150 fits about the connector housing 140 configured as a male plug connector where a portion of the connector housing 140 is inserted into the complimentary mating device. Connectors using other components or configurations may be used with the connector concepts disclosed.

The outer housing 150 of connector 100 has a latching trigger 152 for cooperating with structure on the connector housing 240 of a complimentary connector 200, thereby securing the optical mating between connectors 100,200 and providing a release that requires depressing of the latching trigger for unmating the connectors 100,200. The outer housing 150 may also include rails 154 on opposing side of the latching trigger 152 for inhibiting unintentional release of the optical mating between connectors. Other structures are also possible for securing the optical mating of connectors. Further, the outer housing 150 may have other structure such as a bridge 151 disposed on the front portion for protecting the latching trigger 152.

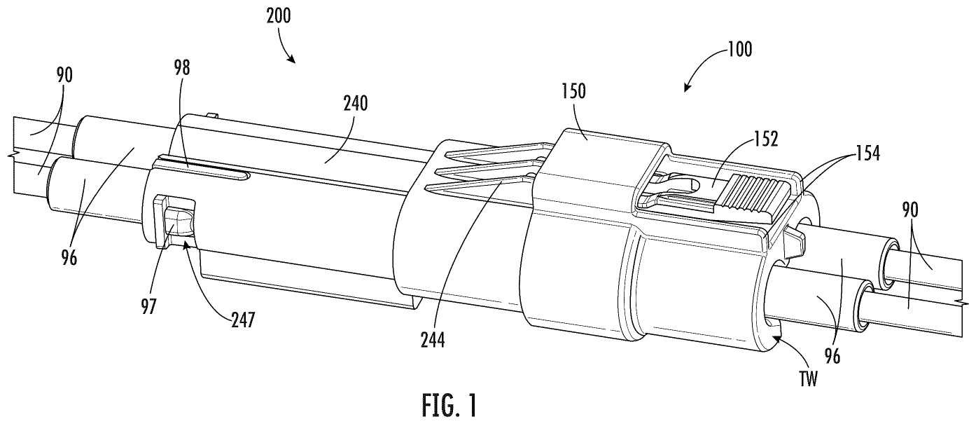

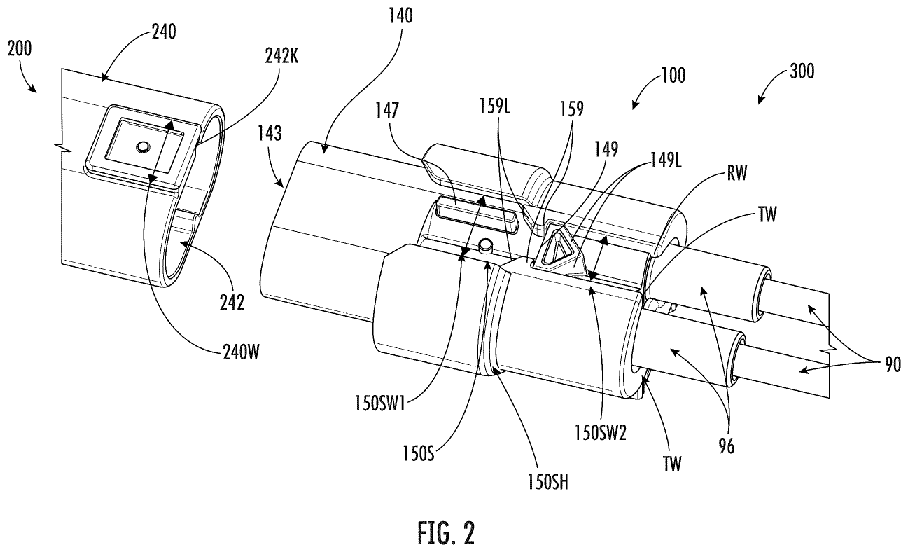

FIG. 1 is a top perspective view of an optical mating of a first cable assembly (not numbered) to a second cable assembly (not numbered) shown with explanatory connectors 100,200. The first cable assembly on the right-side is terminated to one or more fiber optic cable(s) 90 with a connector 100 configured as a male plug that is optically mated to second cable assembly on the left-side and is terminated to fiber optic cable(s) 90 with a connector 200 configured as a female receptacle. A portion of connector 100 fits into a passageway 242 of connector 200 for optical mating as shown by FIG. 2 where the connector 100 is unplugged from connector 200 as viewed from the bottom side of the connectors and cable assembly 300.

As shown in FIG. 1, connector 100 comprises an outer housing 150 having a latching trigger 152 disposed on the top side (i.e., second side) of the outer housing for allowing the unmating of connector 100 from connector 200 when depressed as desired. Outer housing 150 also comprises a longitudinal open slot 150S extending from a front end 153 to a rear end 155 and disposed on a bottom side (i.e., first side) of the outer housing 150 as shown in FIG. 2. As shown, the longitudinal open slot 150S interrupts the circumferential hoop of outer housing 150, thereby allowing the assembly of the outer housing 150 to the connector 100 by passing the optical fiber or cable through the longitudinal open slot 150S for attachment to the connector 100 or removal of the outer housing 150. Outer housing 150 may engage a portion of a connector housing 140 for securing the outer housing 150 to connector 100 for assembly.

As shown in FIGS. 1 and 2, connectors 100,200 are duplex connectors with each connector 100,200 having two ferrule assemblies 60 that are at least partially disposed within the respective connector housings 140,240, but the concepts may be used with any suitable number of ferrule assemblies. The duplex connectors may use connector housings 140,240 having furcated passageways 142,242 (i.e., a first passageway and a second passageway) aligned side-by-side for receiving respective ferrule assemblies 60. Likewise, the concepts may be scaled for connectors having more than two ferrule assemblies 60 or a connector having a single ferrule assembly.

FIG. 2 depicts details of the second side of connector 100 (i.e., the bottom side). As depicted, the connector housing 140 has features that cooperate with the outer housing 150 having a longitudinal open slot 150S. Connector 100 may include further features for functionality as desired. By way of example, outer housing may comprise one or more latch features 159 extending inward toward the longitudinal open slot 150S configured for engaging a protrusion 149 disposed on the connector housing 140. Latch features 159 may cooperate with the geometry of the protrusion 140 as desired for retention of the outer housing 150 when assembled. Latch features 159 of outer housing 150 or protrusion 149 of connector housing 140 may have any suitable geometry for allowing assembly or removal from the connector in a suitable fashion.

By way of example, the protrusion 149 of connector housing 140 may comprise a front end 149FE that is wider than a rear end 149RE, but other geometries are possible for the protrusion. In this instance, protrusion 149 has front end 149FE configured as a flat surface and rear end 149RE configured to converge to a smaller portion. For instance, the rear end 149RE may converge to a truncated end or to a point that is narrower that the front end 149FE as depicted in FIG. 2. As depicted, latch features 159 disposed on outer housing 150 cooperate with the connector housing 140 for assembly. For instance, latch features 159 of outer housing 150 cooperate with the protrusion 149 of connector housing 140 for positioning during assembly. Specifically, the front end 149FE of protrusion 149 aids in positioning the outer housing 150 for assembly by locating the latch features 159 forward of the front end 149FE of the protrusion 149 of the connector housing 140 (i.e., toward the mating interface side). Protrusion 149 may also include lead-in portions 149L if desired for aiding in the installation of the outer housing 150. The lead-in portions 149L of protrusion 149 depicted are angle surfaces that act as ramps for aligning and flexing open the outer housing 150 for installation. Of course, other shapes and arrangements are possible for the protrusion 149 of connector housing 140 and cooperating latch features on the outer housing 150 of connector 100.

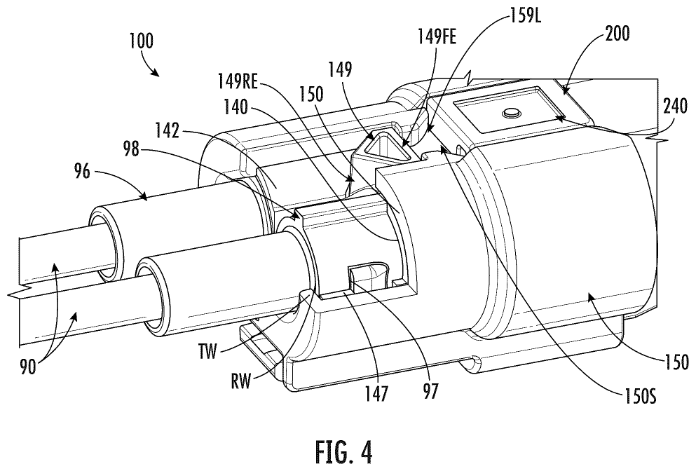

When the outer housing 150 is fully-seated on the connector housing 140 it positions other related geometry of the outer housing 150. Outer housing 150 also comprises a transverse wall (TW) for inhibiting ferrule assemblies 60 from being displayed by excess rearward movement in the passageway 142 of the connector housing 140 when installed. Transverse wall (TW) of outer housing 150 acts to keep respective ferrule assemblies 60 in the respective passageway 142 of the connector housing 140 at a desired longitudinal position for providing ferrule assembly position assurance when connector 100 is mated such as shown in FIG. 4. Consequently, the transverse wall (TW) inhibits respective ferrule assemblies 60 from being displaced from the respective passageway 142 of connector housing 140. The transverse wall (TW) may cooperate with a suitable retaining wall (RW) for inhibiting ferrule assemblies 60 from being displaced from passageway 142. Retaining wall (RW) may be disposed on any suitable component for cooperating with the ferrule assemblies 60.

With the longitudinal open slot 150S, the outer housing 150 has a generally c-shaped cross-section so it can flex during assembly or removal from the connector housing 140. Connector housing 140 provides a male plug configuration for connector 100 having a portion that fits within a passageway 242 of complimentary connector 200 for optical mating. Connector housing 140 provides a rigid body and can have other features for cooperating with outer housing 150.

By way of example, the outer housing 150 can have a front portion that is larger than the rear portion of the outer housing 150 if desired. Further, the longitudinal open slot 150S of the outer housing 150 may have a width that varies at different locations. By way of example, and not limitation, a first slot width 150SW1 may be larger than a second slot width 150SW2 for the outer housing 150 as desired. As depicted, the slot width at the forward portion of the outer housing 150 may be sized for cooperating with a portion 240W of the connector housing 240 for connector 200.

Connectors 100 disclosed herein may have still further advantageous features. As best shown in FIG. 2, connector 100 may comprise one or more keys for inhibiting optical mating with a non-compliant connector or device. As shown, connector housing 140 may comprise one or more keys 147 formed therein that are configured to cooperate with the counterpart features on complimentary connector 200 for limiting the optical mating of connector 100 to a suitable device or wiring scheme. The key 147 of connector may be disposed at any suitable location on the connector 100 and have a desired profile (i.e., male or female with the desired shape) for allowing mating with a compliant connection or device. As depicted, key 147 is a protruding key having a shape with a width, a height and a location for being received within a complimentary keyway of connector 200 that is appropriately sized and shaped. Variations in keying may include changing the width, the height and/or the location of the key on connector 100 for making distinct mating profiles for connector 100. Consequently, a wiring assembly or harness end could have two or more connectors 100 disposed on an end of the assembly with each connector 100 having a distinct keying profile adapted for mating with a distinct counterpart connector so that the connectors of the wiring assembly or harness only mate in the desired orientation with the counterpart assembly for eliminating errors in initial installation and any subsequent service.

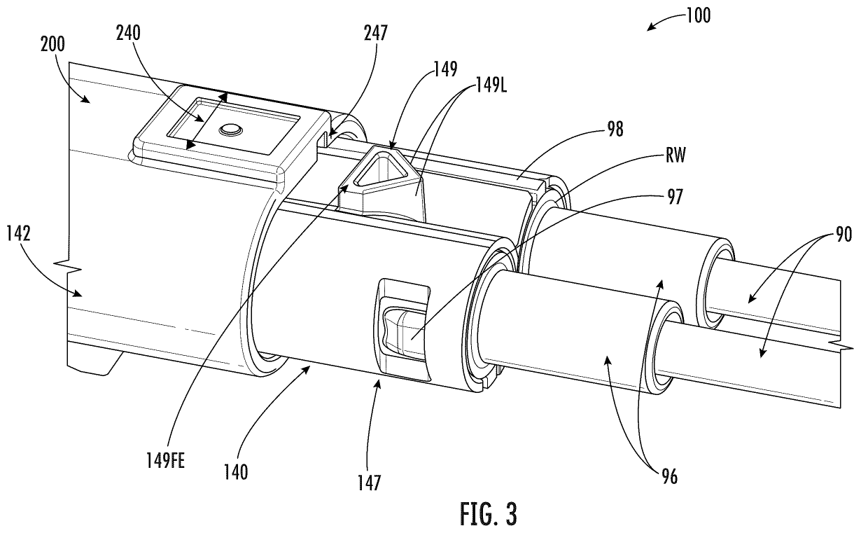

FIG. 3 is a is a top perspective view of an optical mating of connector 100,200 with the outer housing 150 of the connector 100 shown in ghost lines for showing details of the connectors 100,200 when optically mated. As shown, a portion of the connector housing 140 is a male plug that fits within a passageway 242 of the complimentary connector 200 as shown. One or more keys may be used on the connector housing 140 for rotational alignment or providing features to ensure correct optical mating.

Illustratively, FIG. 3 shows an explanatory optional keying arrangement of the key 147 of connector 100 being aligned and inserted into the keying feature 247 of connector 200 that is configured as an appropriately sized slot with a given location that only allows optical mating with the desired complimentary connector 100. Thus, various different arrangements are possible for creating unique mating pairs of optical connectors as desired.

Connectors may further use one or more boots 96 if desired. Boots 96 may provide several different features from providing bending strain relief and/or aiding in securing the terminated ferrule assembly 60 to the connector housing 140. Boot 96 may also include an attachment feature 97 such as a protrusion for securing the boot 96 to the housing 140 by snap-fitting into window 147 formed in the connector housing 140 once the terminated ferrule assembly 60 is fully-inserted into the passageway 142 of the connector housing 140. Consequently, the terminated ferrule assembly 60 is inhibited from being pulled-out of the connector housing. As depicted, the boot 96 may include one or more alignment features 98 such as a rail (i.e., longitudinal protrusion) or the like that cooperates with a cooperating alignment feature on the connector housing 140 such as a corresponding slot or the like.

As shown in FIG. 3, boot 96 may include an attachment feature 97 for securing the boot 96 to the housing 140 by snap-fitting into window 147 formed in the housing once the terminated ferrule assembly 60 is fully-inserted into the passageway 142 of the connector housing 140. Consequently, the terminated ferrule assembly 60 is inhibited from being pulled-out of the connector housing. Further, the boot 96 may include one or more alignment features 98 such as a rail (i.e., longitudinal protrusion) or the like that cooperates with a cooperating alignment feature on the connector housing such as a slot or the like for rotational alignment.

FIG. 4 is partial perspective sectional view of the optical mating of connectors 100,200 similar to FIG. 1 showing the details for the cooperation between the outer housing 150 and components of connector 100. As depicted, the transverse wall (TW) inhibits retaining wall (RW) from being displaced, thereby inhibiting ferrule assemblies 60 from being displaced from passageway 142. In this instance, the retaining wall (RW) is disposed on a shoulder of boot 96, but the retaining wall could be disposed on other components such as disposed on the ferrule assembly 60 if the connector 100 did not use a boot 96. As best shown in FIG. 4, retaining wall (RW) disposed on the boot 96 is disposed generally flush with the rear end of the connector housing 140 when assembled. When assembled, the transverse wall (TW) of the outer housing 150 cooperates with the retaining wall (RW) for inhibiting undue displacement of the ferrule assemblies 60. When the outer housing 150 is removed, it is possible to release and remove the respective boot 96 from the connector housing 140 if desired.

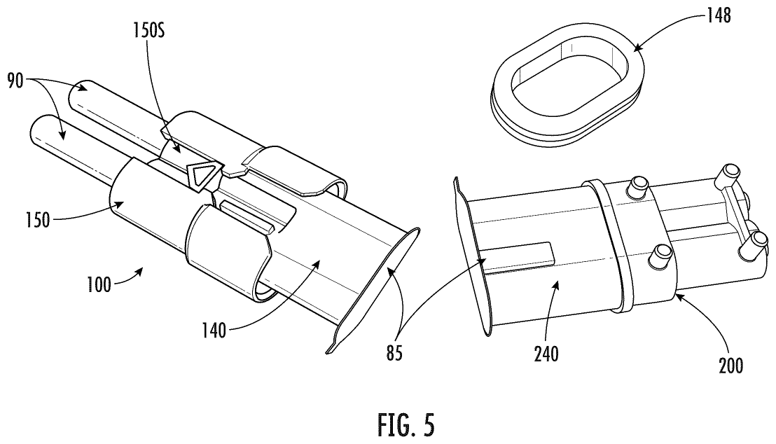

FIG. 5 depicts the connector 100 having a sealing membrane 85 disposed about the opening on the front end 143 of the connector housing 140 for inhibiting contaminants from reaching the optical interface (e.g., the mating interface) prior to optical mating of connector 100. The sealing membrane 85 may be removed from the connector housing 140 for optical mating when desired. Sealing membrane 85 may be used with or without a dust cap on the ferrule assembly 60 as desired.

The connectors disclosed comprise a connector housing 140 where the optical interface of one or more ferrules or the like is disposed within the passageway 142 of the connector housing 140 and disposed rearward of the front end 143 so that a sealing membrane 85 may be disposed on the front end about a perimeter of the connector housing for inhibiting contaminants from reaching one or more ferrules of the connector.

The sealing membrane 85 may be attached to a perimeter of a connector housing in a suitable manner so that the sealing membrane 85 provide environmental protection while intact on the connector 100. The sealing membranes 85 disclosed are distinct from conventional dust caps since they are attached to the connector housing by swaging, adhesive or the like about a perimeter of the front end of the connector housing 140, thereby providing environmental protection until optical mating is desired. The sealing membrane concepts disclosed for fiber optic connectors also allow quick and easy removal and/or piercing of the sealing membrane 85 for optical mating of connector 100. For instance, the sealing membrane 85 may be removed from the connector housing 140 using one or more pull tabs on the sealing membrane 85 or the sealing membrane 85 may be pierced for providing access to the passageway 142 of the connector housing 140 for optical mating.

Generally speaking, the fiber optic connectors disclosed having the sealing membrane 85 provide a one-use sealing feature for the fiber optic connector such as for in-vehicle applications or the like, thereby advantageously providing a fiber optical connector with quick and easy removal of the sealing membrane 85 for building wiring harnesses without the need to dispose or maintain a dust cap in close proximity to the fiber optic connector for future use like the conventional fiber optic connectors. Moreover, the sealing membrane 85 of connector 100 may also remain intact until the wiring harness is placed into the vehicle, thereby providing flexibility for manufacture.

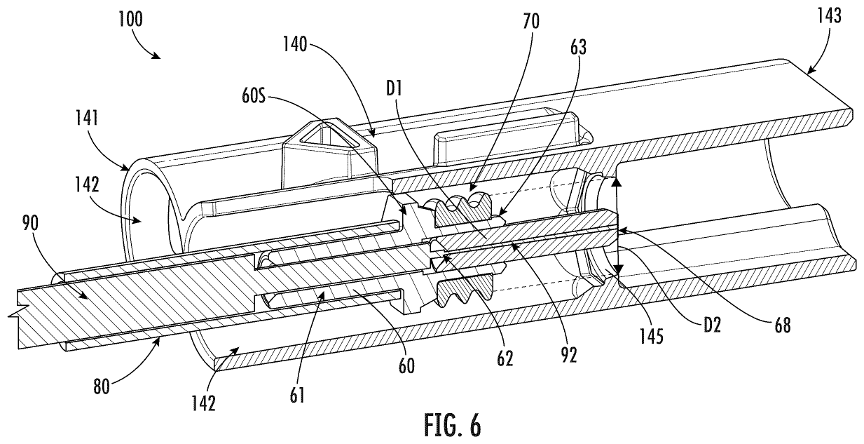

As shown in FIG. 6, connector 100 comprises at least one ferrule assembly 60 for optical mating, but may have any suitable number of ferrule assemblies. Ferrule assembly 60 comprises a bore 62 extending from a rear end 61 into the ferrule assembly 60 along with an optical interface 68 disposed at the front end of the ferrule assembly 60. An optical fiber 92 may be disposed within the bore 62 of the ferrule assembly.

The disclosed connectors may have other optional features. For example, connector 100 may further include an optional sealing gasket 70 is disposed about a portion of the ferrule assembly 60 for inhibiting contaminants from reaching the optical interface 68 of the ferrule assembly 60 when the connector 100 is mated. Each connectors 100 comprises a respective connector housing 140 for supporting the ferrule assembly. Connector housing 140 comprises passageway 142 extending from a rear end 141 to a front end 143 of the connector housing 140, and the respective ferrule assembly 60 is at least partially disposed within the passageway 142.

Duplex connectors comprise a second ferrule assembly 60 comprising a second sealing gasket 70 disposed on the second ferrule assembly 60 like the first ferrule assembly, thereby providing the sealing gasket 70 within the respective passageway. As depicted, sealing gasket 70 is disposed within the respective passageway(s) 142 of the connector housing 140 of connector 100. Thus, mated connectors according the concepts disclosed may create a sealing cavity within the passageway of the connector housing(s) when optically mated. The disclosed concepts provide a robust and reliable connector in a compact package that is quick and easy to assemble, manufacture, disconnect and reconnect as needed.

Connectors disclosed may also have still other structures or features as desired depending as desired. For instance, connectors 100 may further include a spring 67 for biasing the ferrule assembly 60 to a forward position for maintain a physical contact between ferrules or the like for mating at the optical interface 68; however, the concepts may be used without the need for a spring. Likewise, connector 200 may include a sleeve 89 for precisely aligning mating ferrule assemblies 60. As shown, sleeve 89 may be disposed in the passageway 242 of connector 200, and each ferrule assembly 60 of the connector has a dedicated sleeve 89 for precision alignment of mating ferrules.

The disclosed connectors may further include supplemental sealing if desired. For instance, a secondary seal may be disposed rearward of the sealing gasket 70 for the connectors. The secondary seal 84 is disposed on an outer surface of the respective boot 96, thereby providing respective secondary sealing cavities within the passageways 142 of the respective connector housing 140. The secondary seal may be formed by any suitable component such as an O-ring or other structure or feature as desired. In this embodiment, the forward portion of the boot 96 may comprise a suitable sized groove for seating the O-ring and providing the secondary sealing cavity with the inner wall of the connector housings 140.

As best shown in FIG. 6, ferrule assembly 60 comprises a rearward portion 61 and a forward portion 63. A shoulder 60S may be disposed between the rearward portion 61 and the forward portion 63 of the ferrule assembly 60, and the sealing gasket 70 is disposed on the forward portion 63 of the ferrule assembly 60. The shoulder 60S allows the sealing gasket 70 to be compressed when the connector 100,200 is mated for creating the sealing cavity when the connectors are optically mated.

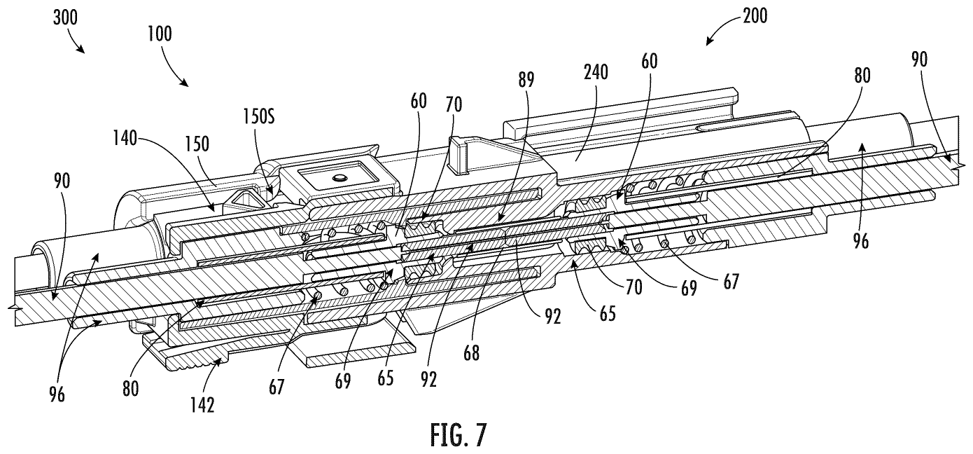

FIGS. 6 and 7 depict sectionals view of connector 100 for showing features that may be used with the connector concepts disclosed. FIG. 6 depicts the insertion of the ferrule assembly 60 terminated to the fiber optic cable 90 as represented by the arrow at the rear of the fiber optic cable 90 during an assembly process, and FIG. 7 depicts an optically mated sectional view of connectors 100,200 configured with ferrule assemblies 60 having the optional sealing gasket 70 and spring 67.

The ferrule assembly 60 may be strain-relieved to the fiber optic cable 90 using a sleeve 80 such as a brass sleeve or the like. Sleeve may be crimped and/or use an adhesive for strain-relieving the cable 90. The sleeve 80 may be slid onto the fiber optic cable 90 and the optical fiber 92 is inserted within the bore 62 of the ferrule assembly 60. As depicted, the sleeve 80 is sized to fit over a rear end 61 of the ferrule assembly 60 and fit over a front portion of the fiber optic cable 90. The sleeve 80 may slid forward on the fiber optic cable 90 to position the sleeve 80 about the rear end 61 of the ferrule assembly 60 and the front portion of the fiber optic cable. Thereafter, the sleeve 80 may be deformed about the front portion of the fiber optic cable 90 and deformed about the rear portion of the ferrule assembly 60 or attached using an adhesives for securing the ferrule assembly 60 to the fiber optic cable 90. Polishing of the ferrule assembly, inspection or other assembly steps may be performed as desired. The sealing gasket 70 may be positioned about a forward portion of the ferrule assembly 60 forward of the shoulder 60S as depicted. The fiber optic cable 90 terminated with the ferrule assembly 60 may be inserted into the rear end 141,241 of passageway 142,242 of the connector housing 140,240 so that the ferrule assembly is at least partially disposed within the passageway 142,242. The sealing gasket 70 may have a diameter D1 that is slightly larger than a diameter D2 of the opening of the housing at the internal wall 145 as depicted. The rear side of the opening at the internal wall 145 may have a tapered surface if desired.

Ferrule assembly 60 may have any suitable optical interface 68 desired. By way of explanation, the connectors 100,200 disclosed may have an optical interface 68 allows optical mating using physical contact or free-space coupling using a lens for the disclosed connectors. Lens-based configurations of connectors may also have the mating interface 68 in physical contact if desired. The ferrule assembly 60 may be configured for physical contact and comprises a ferrule 65 at least partially disposed in a ferrule holder 69 as depicted in FIG. 6. In this configuration, the ferrule holder 69 comprises a forward portion 69F and a rearward portion 69R with shoulder 60S disposed between the forward portion 60F and the rearward portion 69R with the ferrule 65 attached to the ferrule holder 69 to form the ferrule assembly 60. Thus, the bore 62 for the physical contact (PC) configurations extend from the rear end to the front end of the ferrule assembly 60 so the optical fiber 92 may extend to the optical interface 68 at the front end of the ferrule assembly 60 for optical mating with a complimentary mating optical fiber/ferrule assembly.

Alternatively, optical interface 68 of the ferrule assembly 60 for connector 100 may comprises a lens. If the ferrule assembly 60 has an optical interface configured as a lens the ferrule assembly 60 may be formed by a single component suitable for transmitting optical signals through the material of the ferrule assembly. In other lens-based configurations, the ferrule assembly 60 may comprise a suitable lens component disposed at the optical interface 68 of the ferrule assembly 60. In other words, the ferrule assembly 60 may have a lens molded-in as part of the ferrule assembly 60 or a separate lens may be attached at the end of the ferrule assembly 60. If ferrule assembly 60 is a lens-based configuration, then the bore 62 typically stops short of the optical interface 68 of the ferrule assembly 60 and the optical fiber 92 cooperates with the lens. If the optical interface 68 comprises a lens, the connector can be used without a spring. Fiber optic connector 100 may also use multi-fiber ferrules assemblies 60 if desired.

Like the other components, sealing gasket 70 may be formed from any suitable material and is preferably selected from a material that is compatible with the material of the connector and provides the desired performance over the intended operating parameters such as temperature, reliability and longevity. Sealing gasket 70 may comprises a silicone, a polybutylene terephthalate (PBT), a polymer material or a rubber material, but other suitable materials are possible. By way of explanation, a silicone material may be useful since it remains stable and pliable over a wide temperature range and/or compression forces. Additionally, the sealing gasket 70 is appropriately sized for providing the desired performance for sealing, compression, etc. Sealing gasket 70 may include one or more ridges 71 (i.e., one or more glands) for the desired performance. As shown, sealing gasket 70 has three ridges 71, but other suitable geometries are possible for the sealing gasket 70.

Any of the connectors 100 disclosed may be a portion of a cable assembly 300 having one or more cables 90 terminated to the respective connectors 100,300. Further, the connectors 100 or cable assemblies 300 disclosed may be used in any desired application. By way of example, the cable assemblies 300 may be a portion of a vehicle such as an automobile or the like with any suitable ferrule assembly count or arrangement such as single, duplex, triplex, quad, etc. For instance, a connector according to the concepts disclosed may have three ferrule assemblies arranged in a linear array as a triplex arrangement disposed within a suitable connector housing and outer housing as disclosed.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A fiber optic connector comprising:
at least one ferrule assembly comprising a bore extending from a rear end into the at least one ferrule assembly, and an optical interface disposed at a front end of the ferrule assembly;
an optical fiber disposed within the bore of the ferrule assembly;
a connector housing comprising a passageway extending from a rear end to a front end, wherein the ferrule assembly is at least partially disposed within the passageway; and
an outer housing comprising a longitudinal open slot extending from a front end to a rear end and disposed on a first side of the outer housing, along with a latching trigger disposed on a second side of the outer housing.

2. The fiber optic connector of claim 1, wherein the rear end of the outer housing comprises a transverse wall for inhibiting the at least one ferrule assembly from being displaced from the passageway of the connector housing.

3. The fiber optic connector of claim 1, wherein the connector housing comprises a key.

4. The fiber optic connector of claim 1, wherein the outer housing comprises one or more latch features extending inward toward the longitudinal open slot configured for engaging a protrusion disposed on the connector housing.

5. The fiber optic connector of claim 1, wherein the second side of the outer housing comprises a bridge for protecting the latching trigger.

6. The fiber optic connector of claim 4, wherein the protrusion of the connector housing comprises a front end that is wider than a rear end of the protrusion.

7. The fiber optic connector of claim 1, further comprising a boot having an attachment feature with the boot being at least partially disposed within the passageway of the connector housing.

8. The fiber optic connector of claim 1, further comprising a sleeve for strain-relieving the at least one ferrule assembly to the optical fiber, and the boot disposed about a portion of the sleeve.

9. The fiber optic connector of claim 1, further comprising a sealing gasket disposed about a portion of the ferrule assembly for inhibiting contaminants from reaching the optical interface of the ferrule assembly when the fiber optic connector is mated.

10. The fiber optic connector of claim 9, wherein ferrule assembly comprises a forward portion and a rearward portion with a shoulder disposed between the forward portion and the rearward portion, and wherein the sealing gasket is disposed on the forward portion of the ferrule assembly.

11. The fiber optic connector of claim 9, further comprising a second ferrule assembly with a second sealing gasket disposed on the second ferrule assembly received within a second passageway of the connector housing.

12. The fiber optic connector of claim 9, further comprising a secondary seal disposed rearward of the sealing gasket.

13. The fiber optic connector of claim 9, wherein the optical interface comprises a lens.

14. The fiber optic connector of claim 9, wherein the at least one ferrule assembly comprises a ferrule that defines the optical interface and is configured for optically mating using physical contact.

15. The fiber optic connector of claim 9, wherein the sealing gasket is disposed within the passageway of the connector housing.

16. The fiber optic connector of claim 1, wherein the fiber optic connector is a portion of a cable assembly.

17. A fiber optic connector comprising:
a ferrule comprising a bore extending from a rear end into the ferrule, and an optical interface disposed at a front end of the ferrule;
a ferrule holder comprising a forward portion and a rearward portion with a shoulder disposed between the forward portion and the rearward portion, and wherein the ferrule is attached to the ferrule holder to form a ferrule assembly;
an optical fiber disposed within the bore of the ferrule;
a connector housing comprising a passageway extending from a rear end to a front end, wherein the ferrule assembly is at least partially disposed within the passageway; and
an outer housing comprising a longitudinal open slot extending from a front end to a rear end and disposed on a first side of the outer housing, along with a latching trigger disposed on a second side of the outer housing, wherein the rear end of the outer housing comprises a transverse wall for inhibiting the at least one ferrule assembly from being displaced from the passageway of the connector housing.

18. The fiber optic connector of claim 17, wherein the connector housing comprises a key.

19. The fiber optic connector of claim 17, wherein the outer housing comprise one or more latch features extending inward toward the longitudinal open slot configured for engaging a protrusion disposed on the connector housing.

20. The fiber optic connector of claim 17, wherein the second side of the outer housing comprises a bridge for protecting the latching trigger.

21. The fiber optic connector of claim 20, wherein the protrusion of the connector housing comprises a front end that is wider than a rear end of the protrusion.

22. The fiber optic connector of claim 17, further comprising a boot having an attachment feature with the boot being at least partially disposed within the passageway of the connector housing.

23. The fiber optic connector of claim 17, further comprising a sleeve for strain-relieving the at least one ferrule assembly to the optical fiber, and a boot disposed about a portion of the sleeve.

24. The fiber optic connector of claim 17, further comprising a sealing gasket disposed about a portion of the ferrule assembly for inhibiting contaminants from reaching the optical interface of the ferrule assembly when the fiber optic connector is mated.

25. The fiber optic connector of claim 24, wherein ferrule assembly comprises a forward portion and a rearward portion with a shoulder disposed between the forward portion and the rearward portion, and wherein the sealing gasket is disposed on the forward portion of the ferrule assembly.

26. The fiber optic connector of claim 24, further comprising a second ferrule assembly with a second sealing gasket disposed on the second ferrule assembly received within a second passageway.

27. The fiber optic connector of claim 24, further comprising a secondary seal disposed rearward of the sealing gasket.

28. The fiber optic connector of claim 17, wherein the optical interface comprises a lens.

29. The fiber optic connector of claim 17, wherein the at least one ferrule assembly comprises a ferrule that defines the optical interface and is configured for optically mating using physical contact.

30. The fiber optic connector of claim 24, wherein the sealing gasket is disposed within the passageway of the connector housing.

31. The fiber optic connector of claim 17, wherein the fiber optic connector is a portion of a cable assembly.

32. A method of making a fiber optic connector comprising:
assembling a ferrule into a ferrule holder to form a ferrule assembly, wherein the ferrule comprises a bore extending from a rear end into the ferrule, and an optical interface disposed at a front end of the ferrule;
placing an optical fiber within the bore of the ferrule;
inserting the ferrule assembly into a passageway of a connector housing that extends from a rear end to a front end of the connector housing so that the ferrule assembly is at least partially disposed within the passageway; and
placing an outer housing comprising a longitudinal open slot extending from a front end to a rear end of the outer housing about the connector housing.

33. The method of claim 32, wherein the rear end of the outer housing comprises a transverse wall for inhibiting the at least one ferrule assembly from being displaced from the passageway of the connector housing.

34. The method of claim 32, wherein the outer housing comprises one or more latch features extending inward toward the longitudinal open slot configured for engaging a protrusion disposed on the connector housing.

35. The method of claim 32, further comprising positioning a sealing gasket about a portion of the ferrule assembly for inhibiting contaminants from reaching the optical interface of the ferrule when the fiber optic connector is mated.

36. The method of claim 35, wherein ferrule holder comprises a forward portion and a rearward portion with a shoulder disposed between the forward portion and the rearward portion of the ferrule holder, and wherein the sealing gasket is positioned on the forward portion of the ferrule holder.

37. The method of claim 32, further comprising the step of forming a second ferrule assembly and positioning a second sealing gasket on the second ferrule assembly, and inserting the second ferrule assembly into the passageway of the connector housing so that the second ferrule assembly is at least partially disposed within the passageway of the connector housing.

38. The method of claim 32, further comprising positioning a secondary seal disposed rearward of the sealing gasket.

39. The method of claim 32, wherein the optical interface comprises a lens or is defined by one or more ferrules that optically mate using physical contact.

40. The method of claim 32, wherein the sealing gasket is disposed within the passageway of the connector housing.

41. The method of claim 32, wherein the fiber optic connector is a portion of a cable assembly.
